(19) United States
(12) Patent Application Publication
(10) Pub. No.: US 2026/0252942 A1
(43) Pub. Date: Aug. 27, 2026

(54) HEISENBERG ERROR MITIGATION

(71) Applicant: International Business Machines Corporation, Armonk, NY (US)

(72) Inventors: Ewout van den Berg, Bronxville, NY (US); Karthik Siva, White Plains, NY (US); Paul Kristan Temme, Ossining, NY (US)

(21) Appl. No.: 19/064,087

(22) Filed: Feb. 26, 2025

(51) Int. Cl. G06N 10/70; G06N 10/20

(52) U.S. Cl. CPC G06N 10/70; G06N 10/20

(57) ABSTRACT

A system for mitigating errors in quantum computing by transforming observables within a Heisenberg picture that can comprise a memory that stores, and a processor that executes, the computer executable components can comprise a propagation component that propagates an inverse noise map through a quantum circuit. The computer executable components can further comprise an adjustment component that applies the inverse noise map to an observable to produce an adjusted observable operator.

### TECHNICAL FIELD

The subject disclosure relates to techniques for mitigating errors in the measurement of an observable within a Heisenberg picture.

### BACKGROUND

Quantum error mitigation enables execution of increasingly large applications on quantum processors without a need for full fault-tolerant quantum computing. Given inherent noise in near-term quantum devices, various error mitigation techniques have been developed to improve computational accuracy while circumventing substantial resource demands of quantum error correction. One such approach, probabilistic error cancellation (PEC), has played a significant role in reducing impact of noise by reconstructing ideal quantum operations through a weighted combination of noisy circuit executions. However, probabilistic error cancellation (PEC) suffers from substantial overhead due to a need for a large number of circuit instances and extensive shot acquisitions to statistically approximate error-free outcomes. These overheads limit practical scalability of probabilistic error cancellation-based methods, particularly for deep quantum circuits and complex observables. As quantum algorithms continue to advance, there is a growing need for alternative error mitigation strategies that maintain accuracy while reducing computational and resource burdens.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that facilitate quantum error mitigation by transforming an observable within a Heisenberg picture are provided.

According to an embodiment, a computer-implemented system is provided. The computer-implemented system can comprise a memory that can store computer executable components. The computer-implemented system can further comprise a processor that can execute the computer executable components stored in the memory, wherein the computer executable components can comprise a propagation component that propagates an inverse noise map through a quantum circuit. The computer executable components can further comprise an adjustment component that applies the inverse noise map to an observable to produce an adjusted observable operator.

According to another embodiment, a computer-implemented method is provided. The computer-implemented method can comprise propagating, by a system operatively coupled to a processor, an inverse noise map through a quantum circuit. The computer-implemented method can further comprise applying, by a system operatively coupled to a processor, the inverse noise map to an observable to produce an adjusted observable operator.

According to yet another embodiment, a computer program product can comprise a computer readable storage medium having program instructions embodied therewith, the program instructions executable by a processor to cause the processor to propagate an inverse noise map through a quantum circuit. The program instructions can also cause the processor to apply, by the processor, the inverse noise map to an observable to produce an adjusted observable operator.

### BRIEF DESCRIPTION OF THE DRAWINGS

FIG. 1 illustrates a block diagram of an example, non-limiting system 100 that facilitate quantum error mitigation by transforming an observable within a Heisenberg picture in accordance with one or more embodiments described herein.

FIG. 2 illustrates a block diagram of an example, non-limiting system that facilitates quantum error mitigation by transforming an observable within a Heisenberg picture in accordance with one or more embodiments described herein.

FIG. 3 illustrates a block diagram of a quantum system that can be employed in connection with the non-limiting systems of FIGS. 1 and 2, in accordance with one or more embodiments described herein.

FIG. 4 illustrates an example, non-limiting representation of propagating inverse noise maps through a quantum circuit, starting from a leftmost map and moving sequentially to an end of a circuit in a left-to-right manner in accordance with one or more embodiments described herein.

FIG. 5 illustrates an example, non-limiting representation of propagating inverse noise maps through a quantum circuit, starting from an end and moving sequentially backward to a beginning in accordance with one or more embodiments described herein.

FIG. 6 illustrates an example, non-limiting representation of combining inverse noise maps at a center of a quantum circuit before propagating them to an end, in accordance with one or more embodiments described herein.

FIG. 7 illustrates a flow diagram of an example, non-limiting method 700 of quantum error mitigation by transforming an observable within a Heisenberg picture in accordance with one or more embodiments described herein.

FIG. 8 illustrates a conceptual diagram of an example, non-limiting method 800 for quantum error mitigation by transforming an observable within a Heisenberg picture in accordance with one or more embodiments described herein.

FIG. 9 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Quantum computing holds potential to outperform classical computation in various applications. However, this potential is significantly hindered by the presence of quantum noise which can degrade computational accuracy and limit scalability of quantum circuits. Unlike classical systems, where error correction can be implemented with relatively low overhead, quantum error correction requires extensive hardware redundancy, making it impractical for near-term quantum devices.

To address this challenge, quantum error mitigation techniques have been to aim to reduce noise effects without the need for full fault tolerance. Unlike quantum error correction, quantum error mitigation focuses on compensating for errors at a quantum circuit level or measurement stage.

Among available quantum error mitigation techniques, probabilistic error cancellation (PEC) provides a significant approach to error mitigation This method models noise channels and inverts them by sampling from an ensemble of circuits with appropriately weighted correction factors. However, probabilistic error cancellation (PEC) introduces substantial computational overhead. Circuit instances and measurement shots required by probabilistic error cancellation (PEC) grows exponentially, with an effective per-gate scaling factor denoted as γ. While advancements in hardware and control methodologies may reduce scaling factor, γ inherently limits a practical number of gates that can be effectively mitigated within a quantum circuit.

Overall, current methods do not optimize mitigation costs for specific observable. Instead, existing methods attempt to mitigate an entire noise model affecting a quantum circuit, resulting in unnecessary computational overhead.

To address issues of quantum error mitigation, an observable-focused approach can be taken. By leveraging a Heisenberg picture to selectively mitigate errors rather than correcting an entire noise model, only relevant components of noise that impact a given observable can be mitigated. By shifting focus to observable-dependent error mitigation, this approach can enable more efficient suppression of noise while avoiding unnecessary overhead associated with full noise model inversion.

Various embodiments of the present disclosure can be implemented to facilitate quantum error mitigation of an observable within a Heisenberg picture. Embodiments described herein include systems, computer-implemented methods, and computer program products that can enhance the accuracy of observable measurements in quantum computing by applying error mitigation techniques within a Heisenberg picture framework.

In an embodiment, as described herein, a propagation component can propagate, on logical or physical qubits of a quantum system, an inverse noise map through a quantum circuit. In various embodiments, a propagation component can propagate the inverse noise map in Liouville space using weighted Pauli strings through the quantum circuit. In some embodiments, a propagation component can split or merge Pauli terms during propagation. In various embodiments, a propagation component can impose a limiting factor on a number of Pauli terms retained during inverse noise map propagation in a non-Clifford quantum circuit. In some embodiments, a propagation component can propagate a first noise channel through at least one gate in the quantum circuit. According to an embodiment, a propagation component can combine the inverse noise map of at least one gate with the inverse noise map of a subsequent gate. In an embodiment, a propagation component iteratively repeats the procedure of propagating and combining the inverse noise map.

In an embodiment, as described herein, an adjustment component can apply the inverse noise map to an observable to produce an adjusted observable operator.

In an embodiment, as described herein, a measurement component can measure the adjusted observable operator as weighted sums of observables contributing to the adjusted observable operator.

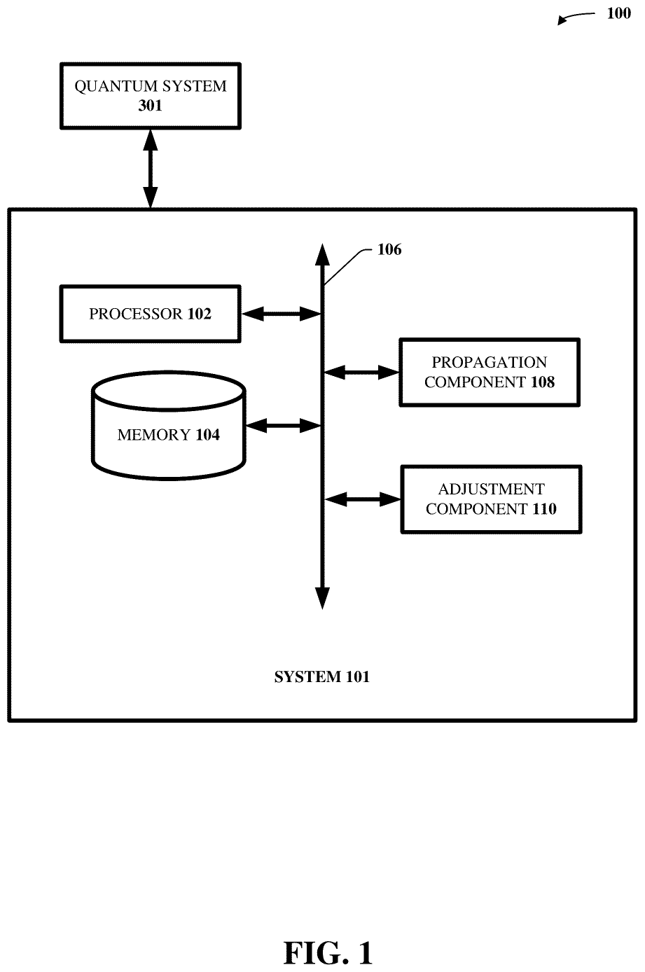

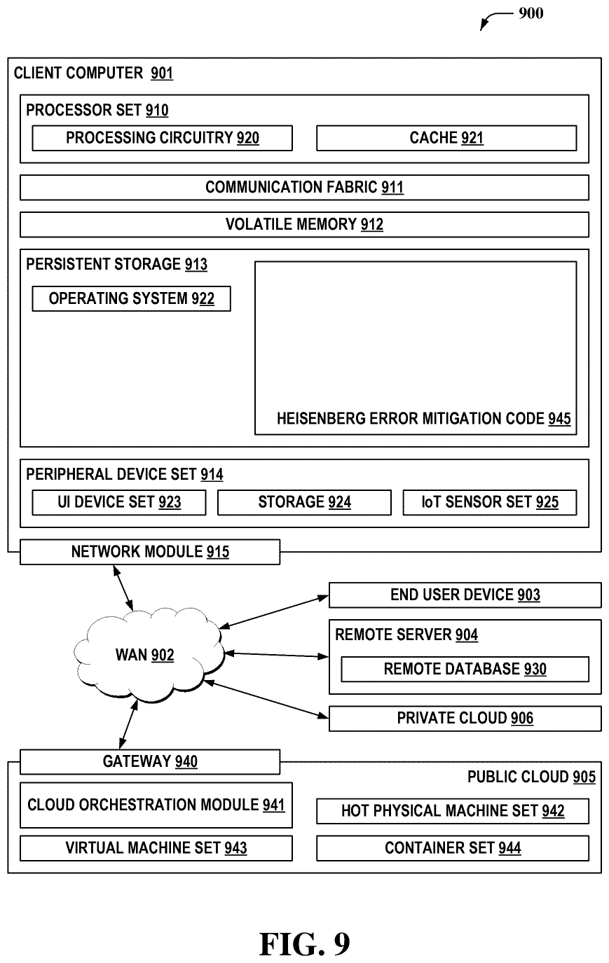

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 900 illustrated at FIG. 9. For example, system 100 can be associated with, such as accessible via, a computing environment 900 described below with reference to FIG. 9 such that aspects of processing can be distributed between system 100 and the computing environment 900. In one or more described embodiments, computer and/or computing-based elements can be used in connection with implementing one or more of the systems, devices, components and/or computer-implemented operations shown and/or described in connection with FIG. 1 and/or with other figures described herein.

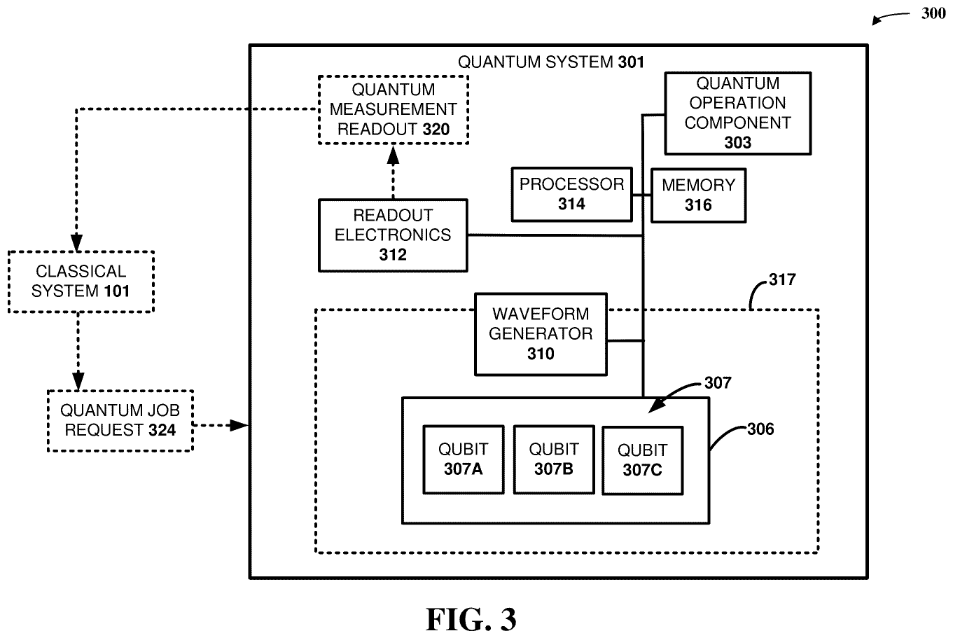

FIG. 1 illustrates a block diagram of an example, non-limiting system 100 that performs quantum error mitigation by transforming an observable within a Heisenberg picture in accordance with one or more embodiments described herein. That is, non-limiting system 100 can enhance accuracy of an observable measurement in quantum computing by applying error mitigation techniques within a Heisenberg picture framework, in combination with employment of a quantum system 301 (FIG. 3). The non-limiting system 100 can comprise a system 101 and a quantum system 301, to be described in detail below. System 101 can comprise processor 102, memory 104, system bus 106, propagation component 108, and adjustment component 110.

The system 100 and/or the components of the system 100 can be employed to use hardware and/or software to solve problems that are highly technical in nature (e.g., mitigating quantum computational errors, improving measurement accuracy of observables, and optimizing quantum circuit performance, etc.), that are not abstract and that cannot be performed as a set of mental acts by a human. Further, some of the processes performed may be performed by specialized computers for carrying out defined tasks. The system 100 and/or components of the system can be employed to solve new problems that arise through advancements in technologies mentioned above, computer architecture, and/or the like. The system 100 can provide technical improvements, including but not limited to enhancing the accuracy of observable measurements in quantum computing, mitigating errors through transformation techniques, optimizing quantum circuit performance, or improving the reliability of quantum-based computations and machine learning models.

Discussion turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., propagation component 108, cost adjustment 110) to perform one or more actions. In one or more embodiments, memory 104 can store computer-executable components (e.g., propagation component 108, cost adjustment 110).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s).

In an embodiment, as described herein, a propagation component 108 can propagate, on logical or physical qubits of the quantum system 301, an inverse noise map through a quantum circuit. In various embodiments, a propagation component can propagate the inverse noise map in Liouville space using weighted Pauli strings through the quantum circuit. In some embodiments, a propagation component can split or merge Pauli terms during propagation. In various embodiments, a propagation component can impose a limiting factor on a number of Pauli terms retained during inverse noise map propagation in a non-Clifford quantum circuit. In some embodiments, a propagation component can propagate a first noise channel through at least one gate in the quantum circuit. According to an embodiment, a propagation component can combine the inverse noise map of at least one gate with the inverse noise map of a subsequent gate. In an embodiment, a propagation component iteratively repeats the procedure of propagating and combining the inverse noise map.

In an embodiment, as described herein, an adjustment component 110 can apply, on logical or physical qubits of the quantum system 301, the inverse noise map to an observable to produce an adjusted observable operator.

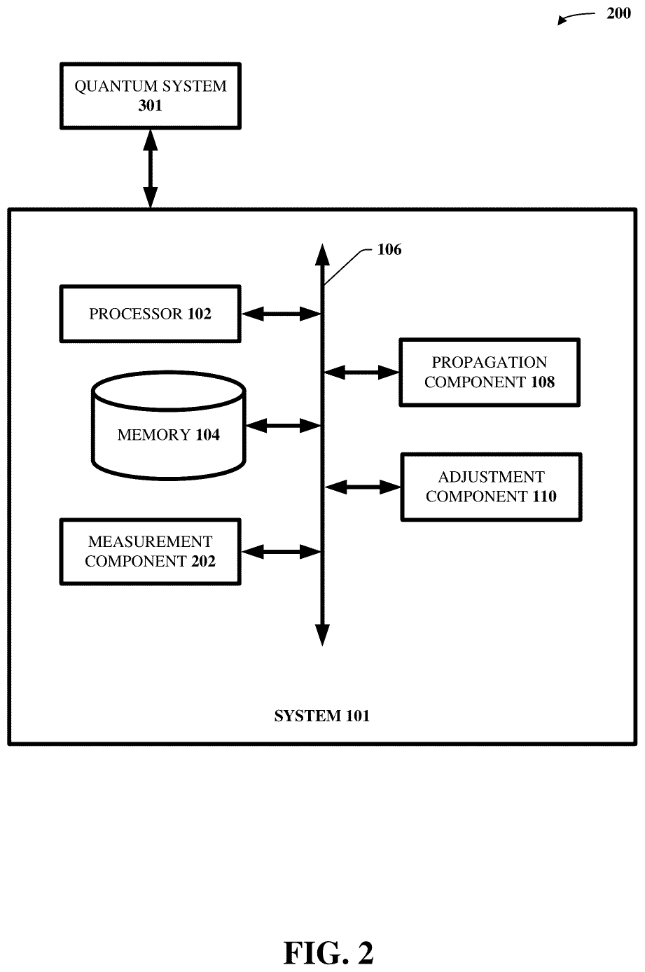

FIG. 2 illustrates a block diagram of an example, non-limiting system 200 that facilitates quantum error mitigation by transforming an observable within a Heisenberg picture in accordance with one or more embodiments described herein. As shown, system 200 can comprise the same components as system 100, and can further comprise a measurement component 202.

In various embodiments, a measurement component 202 can measure the adjusted observable operator as weighted sums of observables contributing to the adjusted observable operator.

Measurement component 202 can facilitate efficient decomposition of adjusted observable into a basis set suitable for measurement, such as Pauli components, or can optimize basis selection to minimize sampling overhead. In some embodiments, measurement component 202 can employ adaptive measurement techniques or error-mitigation strategies tailored to characteristics of noise affecting the quantum circuit. By leveraging these approaches, measurement component 202 can enhance accuracy of quantum computations while mitigating computational complexity.

Turning to FIG. 3, one or more embodiments described herein can include one or more devices, systems and/or apparatuses that can provide a process to apply quantum machine learning models. Accordingly, at FIG. 3, illustrated is a block diagram of an example, non-limiting system 300 that can at least partially facilitate such a process. While referring here to one or more processes, facilitations and/or uses of non-limiting system 300, description provided herein, both above and below, also can be relevant to one or more other non-limiting systems described herein, such as non-limiting systems 100 or 200.

As illustrated in FIGS. 1 and 2, non-limiting system 100 and 200 can comprise a quantum system 301 that can be employed with or separate from classical system 101.

Generally, quantum system 301 (e.g., quantum computer system, superconducting quantum computer system and/or the like) can employ quantum algorithms and/or quantum circuitry, including computing components and/or devices, to perform quantum operations and/or functions on input data to produce results that can be output to an entity. Quantum circuitry can comprise quantum bits (qubits), such as multi-bit qubits, physical circuit level components, high level components and/or functions. Quantum circuity can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 320, can be responsive to the quantum job request 324 and associated input data and can be based at least in part on the input data, quantum functions and/or quantum computations.

In one or more embodiments, the quantum system 301 can comprise components, such as a quantum operation component 303, a quantum processor 306, pulse component 410 (e.g., a waveform generator) and/or readout electronics 312 (e.g., readout component). In one or more other embodiments, the readout electronics 312 can be comprised at least partially by the classical system 101 and/or be external to the quantum system 301. The quantum processor 306 can comprise one or more, such as plural, qubits 307. Individual qubits 307A, 307B and 307C, for example, can be fixed frequency and/or single junction qubits, such as transmon qubits.

In one or more embodiments, a memory 316 and/or processor 314 can be associated with the quantum operation component 303, where suitable. The processor 314 can be any suitable processor. The processor 314 can generate one or more instructions for controlling the one or more processes of the quantum operation component 303.

The quantum operation component 303 can obtain (e.g., download, receive, search for and/or the like) a quantum job request 324 requesting execution of one or more quantum programs on a physical qubit layout. The quantum job request 324 can be provided in any suitable format, such as a text format, binary format and/or another suitable format. In one or more embodiments, the quantum job request 324 can be obtained by a component other than of the quantum system 301, such as a by a component of the classical system 101.

The quantum operation component 303 can determine mapping of one or more quantum logic circuits for executing a quantum program. In one or more embodiments, the quantum operation component 303 and/or quantum processor 306 can direct the waveform generator 310 to generate one or more pulses, tones, waveforms and/or the like to affect one or more qubits 307, such as in response to a quantum job request 324.

The waveform generator 310 can generally cause the quantum processor 306 to perform one or more quantum processes, calculations and/or measurements by creating a suitable electro-magnetic signal. For example, the waveform generator 310 can operate one or more qubit effectors, such as qubit oscillators, harmonic oscillators, pulse generators and/or the like to cause one or more pulses to stimulate and/or manipulate the state(s) of the one or more qubits 307 comprised by the quantum system 301.

The quantum processor 306 and a portion or all of the waveform generator 310 can be contained within a cryogenic environment, such as that generated by a cryogenic environment 317, which may be implemented using a dilution refrigerator or other suitable cryogenic technology. The waveform generator 310 can generate signals to interact with one or more of the plurality of qubits 307. Where the plurality of qubits 307 are superconducting qubits, cryogenic temperatures, such as approximately 4K or lower, may be employed for their operation. Accordingly, one or more elements of the readout electronics 312 can also be constructed or adapted to function at such cryogenic temperatures.

The readout electronics 312, or at least a portion thereof, can be contained within the cryogenic environment 317 and can be configured to facilitate reading one or more characteristics of one or more qubits, such as state, frequency, excitation, decay, or other properties.

The preceding descriptions are not intended to be limited to the operation of a single set of instructions on a single qubit. Rather, scaling can be achieved in various ways. For example, instructions can be computed, transmitted, executed, and/or otherwise applied relative to one or more qubits, which may include but are not limited to non-neighbor qubits, multiple quantum circuits in parallel, and/or multiple qubit mappings in parallel. Additionally, signals generated by the waveform generator 310 may interact with multiple qubits individually or collectively, in a sequential or parallel manner, depending on implementation.

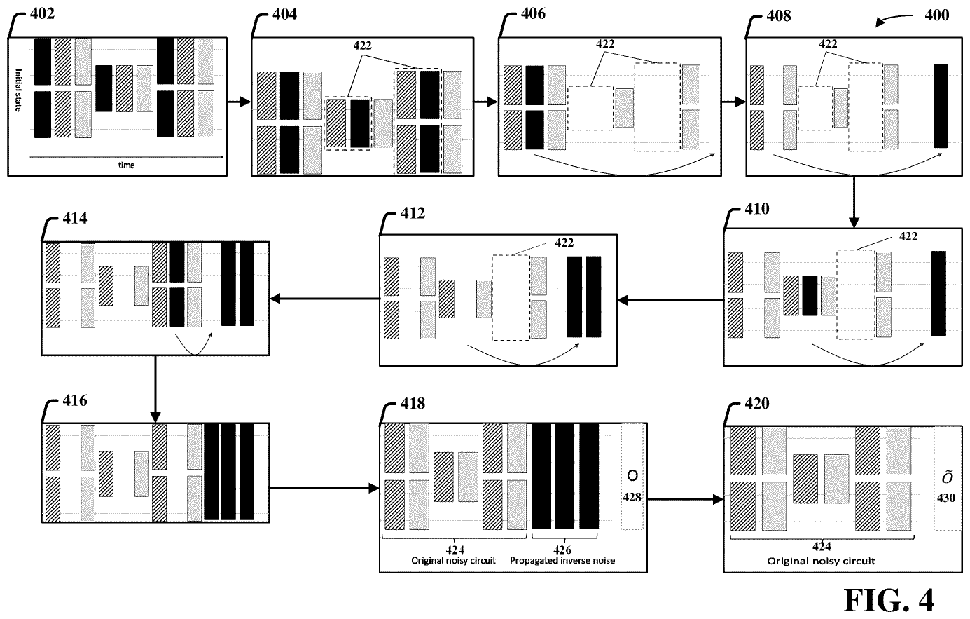

FIG. 4 illustrates an example, non-limiting representation of propagating inverse noise maps through a quantum circuit, starting from a leftmost map and moving sequentially to an end of a circuit in a left-to-right manner in accordance with one or more embodiments described herein.

In one embodiment, inverse noise maps are propagated through a quantum circuit sequentially from left to right. In other embodiments, different ordering schemes for propagating inverse noise maps through a quantum circuit may be utilized.

In FIG. 4, a black block represents an inverse noise map, a striped block represents a noise channel, and a gray block represents an ideal gate. The x-axis denotes time, while the y-axis represents different qubits.

At 402, a graph illustrates a quantum circuit after an application of probabilistic error cancellation (PEC). In PEC, inverse noise maps (represented by black blocks) are positioned before layers of noisy gates, which consist of noisy channels (striped blocks) and ideal gates (gray blocks).

At 404, order of a noise channel and its corresponding inverse noise map can be reordered such that a noise channel is swapped with its paired inverse noise map. Each paired noise channel and its corresponding inverse noise map collectively form an identity operator 422.

Upon successfully swapping a leftmost inverse noise map with its corresponding noise channel, an inverse noise map can be propagated through a remainder of a quantum circuit at 406, without interacting with other noise channel and inverse noise map pairs.

In various embodiments where noise within a quantum circuit is represented by a Pauli channel or a sparse Pauli-Lindblad channel, noise propagation through a quantum circuit can be facilitated using techniques from Clifford perturbation theory. In various embodiments, approximations can be employed to enable noise propagation while mitigating computational complexity.

At 408, a left-most inverse noise map can be successfully pushed to an end of a quantum circuit.

An inverse noise map, denoted as M, followed by a layer of ideal gates, G, can be represented as G ∘M. Propagation of M though G can be performed using a transformation G ∘M∘G^{†}∘G. A resulting propagated though channel can be represented as M′=G ∘M∘G^{†}. An overall operation can be expressed as M′∘G, where G precedes M′.

At 410, the process can be repeated to propagate a current leftmost inverse noise map through a remainder of a quantum circuit while ignoring any other noise channel and inverse noise map pairs.

At 412, a current leftmost inverse noise map has been successfully propagated through a remainder of a quantum circuit.

At 414, the process continues iteratively, propagating each successive leftmost inverse noise map through a remainder of a quantum circuit. The process repeats itself until all inverse noise maps have been pushed toward an end of a quantum circuit.

At 416, all inverse noise maps have been fully propagated to an end of a quantum circuit in reverse order.

Upon completion of the propagation process, at 418, an observable, O, can be measured. In FIG. 4, element 424 represents an original noisy circuit, while element 426 corresponds to a propagated inverse noise.

At 420, instead of incorporating an inverse noise map directly within a quantum circuit, an alternative approach can be employed by transitioning to a Heisenberg picture. In this approach, an observable can be modified by applying an adjoint inverse noise map. A transformed observable can then be decomposed, and in certain embodiments, it can be expressed in terms of its Pauli components. A corresponding observable values can be measured in a suitable basis or set of bases.

An adjusted observable operator, Õ, can be computed by the weighted sum of decomposed (Pauli) observables. Since a Heisenberg picture approach modifies only an observable rather than a quantum circuit itself, a structure of a quantum circuit remains unchanged. Therefore, in FIG. 4, only element 424, representing an original noisy circuit, is depicted, as inverse noise is conceptually applied at the measurement stage rather than within a quantum circuit itself.

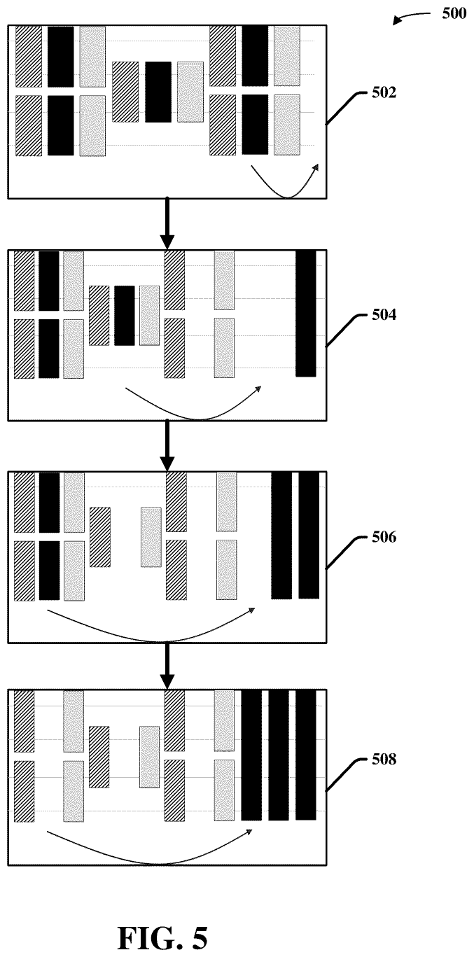

FIG. 5 illustrates an example, non-limiting representation of propagating inverse noise maps through a quantum circuit, starting from an end and moving sequentially backward to a beginning in accordance with one or more embodiments described herein.

At 502, a graph illustrates a quantum circuit after an application of probabilistic error cancellation (PEC). In probabilistic error cancellation (PEC), inverse noise maps (represented by black blocks) can be positioned after layers of noisy gates, which include noisy channels (striped blocks). Ideal gates (gray blocks) can be after inverse noise maps.

At 504, a next rightmost inverse noise map has been successfully propagated to an end of a quantum circuit.

At 506, a subsequent rightmost inverse noise map is propagated toward an end of a quantum circuit, ensuring it does not move beyond previously propagated inverse noise maps. This process can involve pushing noise through remaining noise channels within a quantum circuit.

At 508, the procedure is repeated iteratively until all inverse noise maps have been fully propagated to an end of a quantum circuit.

Once all inverse noise maps have been processed, direct application to an observable is achieved, eliminating the need for storage in memory.

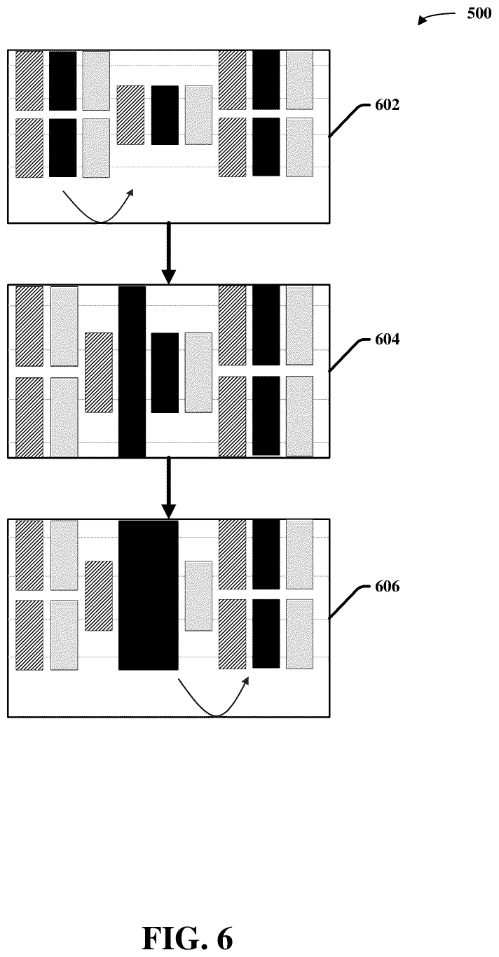

FIG. 6 illustrates an example, non-limiting representation of combining inverse noise maps at a center of a quantum circuit before propagating them to an end, in accordance with one or more embodiments described herein.

In certain embodiments, a variation approach can involve selecting a leftmost inverse noise map, propagating it until it reaches a next inverse noise map, combining two inverse noise maps, and repeating this process iteratively. Each iteration can begin with a newly formed leftmost combined inverse noise map. In other embodiments, various sequential approaches can be employed, such as propagating inverse noise maps from right to left while iteratively combining them or utilizing alternative propagation sequences based on circuit architecture and computational constraints.

At 602, a leftmost inverse noise map is selected for propagation toward the next inverse noise map.

At 604, the combined inverse noise map can further proceed through a remainder of the quantum circuit. This process involves sequentially pushing inverse noise maps through a quantum circuit, combining inverse noise maps upon interaction, and continuing to propagate a newly formed combined inverse noise map through the proceeding layers of a quantum circuit.

At 606, a newly generated combined inverse noise map is formed and propagated through a quantum circuit. Updates to an observable can be performed as soon as some portion of inverse noise has been propagated to an end of a quantum circuit. That is, it is not necessary to wait until all noise has been fully propagated before making such updates.

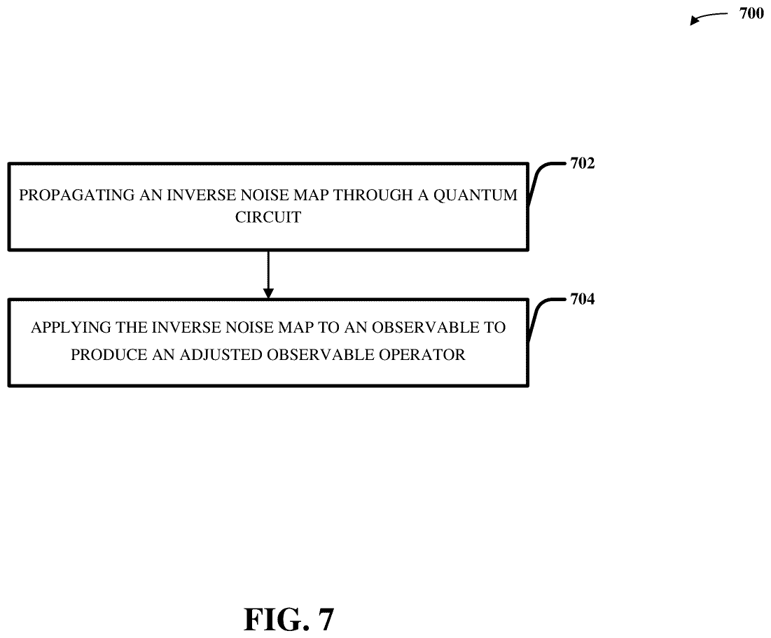

FIG. 7 illustrates a flow diagram of an example, non-limiting method 700 of quantum error mitigation by transforming an observable within a Heisenberg picture. Repetitive description of like elements and/or processes employed in respective embodiments is omitted for sake of brevity.

At 702, non-limiting method 700 can comprise propagating (e.g., by a propagation component 108), by the system, an inverse noise map through a quantum circuit. Propagation of the inverse noise map can be performed using various techniques, such as Pauli-based propagation, Clifford perturbation theory, or iterative combination methods, ensuring an inverse noise map is effectively applied to counteract noise effects within a quantum circuit.

At 704, non-limiting method 700 can comprise applying (e.g., by an adjustment component 110), by the system, the inverse noise map to an observable to produce an adjusted observable operator. Instead of modifying a quantum circuit itself, an inverse noise map can be incorporated into an observable, aligning with a Heisenberg picture approach. An adjusted observable operator can account for propagated noise effects, allowing for improved measurement accuracy without requiring direct circuit modifications.

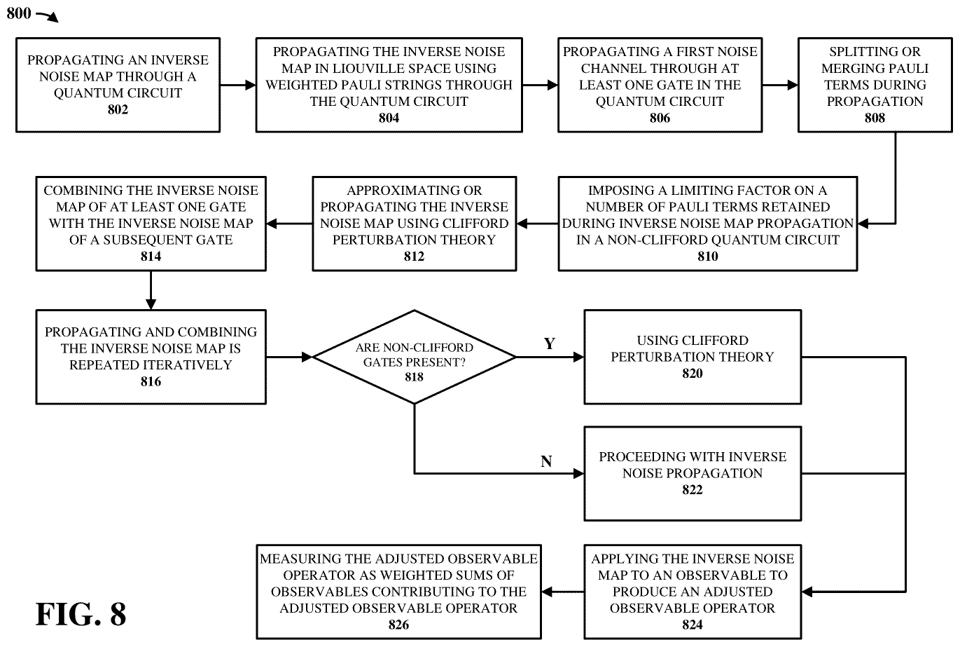

FIG. 8 illustrates a conceptual diagram of an example, non-limiting method 800 for quantum error mitigation by transforming an observable within a Heisenberg picture in accordance with one or more embodiments described herein. Rather than representing a strict sequential flow, the diagram presents a collection of ideas and concepts related to the method. Repetitive description of like elements and/or processes employed in respective embodiments is omitted for the sake of brevity.

At 802, non-limiting method 800 can comprise propagating (e.g., by a propagation component 108), by the system, an inverse noise map through a quantum circuit. Propagating an inverse noise map facilitates error mitigation by accounting for noise effects at various locations within a quantum circuit.

At 804, non-limiting method 800 can comprise propagating (e.g., by a propagation component 108), by the system, the inverse noise map in Liouville space using weighted Pauli strings through the quantum circuit. This approach can represent noise in terms of a basis of weighted Pauli operators, allowing for an efficient and tractable method to correct quantum noise.

At 806, non-limiting method 800 can comprise propagating (e.g., by a propagation component 108), by the system, a first noise channel through at least one gate in the quantum circuit.

At 808, non-limiting method 800 can comprise splitting or merging (e.g., by a propagation component 108), by the system, splitting or merging Pauli terms during propagation. Splitting Pauli terms can provide finer resolution in noise analysis. Merging similar terms can reduce computational complexity.

At 810, non-limiting method 800 can comprise imposing (e.g., by a propagation component 108), by the system, a limiting factor on a number of Pauli terms retained during inverse noise map propagation in a non-Clifford quantum circuit. Limiting a number of retained terms can prevent exponential computational overhead while preserving the most significant noise contributions.

At 812, non-limiting method 800 can comprise approximating or propagating (e.g., by a propagation component 108), by the system, the inverse noise map using Clifford perturbation theory. Clifford perturbation theory can provide an approximation framework to efficiently mitigate non-Clifford noise effects.

At 814, non-limiting method 800 can comprise combining (e.g., by a propagation component 108), by the system, the inverse noise map of at least one gate with the inverse noise map of a subsequent gate.

At 816, non-limiting method 800 can comprise propagating (e.g., by a propagation component 108), by the system, and combining the inverse noise map is repeated iteratively.

At 818, non-limiting method 800 can analyze the structure of a quantum circuit to assess the presence of non-Clifford gates. Since the propagation of noise through the circuit already accounts for non-Clifford gates, this step may not be required in all implementations. However, in certain embodiments, specific techniques for handling non-Clifford noise effects can be utilized as described in related claims.

At 820, if non-Clifford gates are present, non-limiting method 800 can comprise using (e.g., by a propagation component 108), by the system, Clifford perturbation theory. Clifford perturbation theory can facilitate efficient mitigation of non-Clifford noise effects while maintaining the overall approach of propagating inverse noise to the end of the circuit and updating the observable.

At 822, if the determination at 818 is negative and the quantum circuit consists only of Clifford gates, non-limiting method 800 can comprise proceeding (by a propagation component 108), by the system, with implementation of inverse noise propagation.

At 824, non-limiting method 800 can comprise applying (e.g., by an adjustment component 110), by the system, the inverse noise map to an observable to produce an adjusted observable operator. An observable can modify a measurement outcome without altering a quantum circuit.

At 826, non-limiting method 800 can comprise measuring (e.g., by a measurement component 202), by the system, the adjusted observable operator as weighted sums of observables contributing to the adjusted observable operator.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human.

FIG. 9 illustrates a block diagram of an example, non-limiting, operating environment in which one or more embodiments described herein can be facilitated. FIG. 9 and the following discussion are intended to provide a general description of a suitable operating environment 900 in which one or more embodiments described herein at FIGS. 1-8 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 contains an example of an environment for the execution of at least some of the computer code involved in performing the inventive methods, such as Heisenberg error mitigation code 945. In addition to block 945, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 945, as identified above), peripheral device set 914 (including user interface (UI), device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 945 in persistent storage 913.

COMMUNICATION FABRIC 911 is the signal conduction paths that allow the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, the volatile memory is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid-state storage devices. Operating system 922 may take several forms, such as various known proprietary operating systems or open-source Portable Operating System Interface type operating systems that employ a kernel. The code included in block 945 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer, and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer executable components stored in memory, wherein the computer executable components comprise:
a propagation component that propagates an inverse noise map through a quantum circuit; and
an adjustment component that applies the inverse noise map to an observable to produce an adjusted observable operator.

2. The system of claim 1, wherein the inverse noise map further comprises at least one of: a Pauli channel or a sparse Pauli-Lindblad noise model.

3. The system of claim 1, wherein the propagation component propagates the inverse noise map in Liouville space using weighted Pauli strings through the quantum circuit.

4. The system of claim 1, wherein the propagation component splits or merges Pauli terms during propagation.

5. The system of claim 1, wherein the propagation component imposes a limiting factor on a number of Pauli terms retained during inverse noise map propagation in a non-Clifford quantum circuit.

6. The system of claim 1, wherein the inverse noise map is approximated or propagated using Clifford perturbation theory.

7. The system of claim 1, further comprising a measurement component that measures the adjusted observable operator as weighted sums of observables contributing to the adjusted observable operator.

8. The system of claim 1, wherein the propagation component propagates a first noise channel through at least one gate in the quantum circuit.

9. The system of claim 1, wherein the propagation component combines the inverse noise map of at least one gate with the inverse noise map of a subsequent gate.

10. The system of claim 1, wherein the procedure of propagating and combining the inverse noise map is repeated iteratively.

11. A computer-implemented method that utilizes a processor that executes computer
executable components stored in memory to perform the following acts:
propagating an inverse noise map through a quantum circuit; and
applying the inverse noise map to an observable to produce an adjusted observable operator.

12. The method of claim 11, further comprising propagating the inverse noise map in Liouville space using weighted Pauli strings through the quantum circuit.

13. The method of claim 11, further comprising splitting or merging Pauli terms during propagation.

14. The method of claim 11, further comprising imposing a limiting factor on a number of Pauli terms retained during inverse noise map propagation in a non-Clifford quantum circuit.

15. The method of claim 11, further comprising approximating or propagating the inverse noise map using Clifford perturbation theory.

16. The method of claim 11, further comprising measuring the adjusted observable operator as weighted sums of observables contributing to the adjusted observable operator.

17. The method of claim 11, further comprising propagating a first noise channel through at least one gate in the quantum circuit.

18. The method of claim 11, further comprising combining the inverse noise map of at least one gate with the inverse noise map of a subsequent gate.

19. The method of claim 11, further comprising propagating and combining the inverse noise map is repeated iteratively.

20. A computer program product comprising a computer readable storage medium having program instructions embodied therewith, the program instructions executable by a processor to cause the processor to:
propagate an inverse noise map through a quantum circuit; and
apply the inverse noise map to an observable to produce an adjusted observable operator.
